(19) United States
(12) Patent Application Publication
(10) Pub. No.: US 2025/0117813 A1
(43) Pub. Date: Apr. 10, 2025

(54) METHODS AND SYSTEMS FOR CLASSIFYING MERCHANTS INTO MERCHANT CATEGORIES

(71) Applicant: MASTERCARD INTERNATIONAL INCORPORATED, PURCHASE, NY (US)

(72) Inventors: Saugandh DATTA, Greater Noida (IN); Himanshu TYAGI, Ghaziabad (IN); Shubham CHAUHAN, New Delhi (IN)

(21) Appl. No.: 18/484,327

(22) Filed: Oct. 10, 2023

(51) Int. Cl. G06Q 30/0201

(52) U.S. Cl. CPC G06Q 30/0201

(57) ABSTRACT

Methods and server systems for performing merchant classification are described herein. The method performed by a server system includes accessing a historical transaction dataset including transaction attributes from a database. Method includes generating a set of key performance features for each merchant of the plurality of merchants based on the historical transaction dataset. Method includes determining a set of hyper-parameters including an epsilon value and a Minimum points (MinPts) value for a clustering machine learning (ML) model based on a K-nearest neighbor (KNN) plot generated based on the set of key performance features for each merchant. Method includes generating via the clustering ML model, a set of merchant clusters based on the set of key performance features for each merchant and the set of hyper-parameters. Method includes labeling each merchant cluster as one of a first merchant class and a second merchant class based on a classification threshold.

### TECHNICAL FIELD

The present disclosure relates to artificial intelligence-based processing systems and, more particularly, to electronic methods and complex processing systems for classifying a plurality of merchants into different merchant categories.

### BACKGROUND

Within the financial sector, there is an ever-increasing number of merchants offering various goods and services to their buyers such as cardholders. Examples of merchants include grocery stores, electronic stores, hotels, fuel pumps, automobile dealerships, and the like. As may be understood, the economic output generated by the transactions performed at such merchants is generally one of the biggest drivers behind the Gross Domestic Product (GDP) of a country. To that end, it is essential to track the performance of various merchants across the nation to determine the GDP and other growth figures. More specifically, it is crucial to determine the growth or operation of merchants across different merchant categories, such as a small/medium merchant category or a large merchant category, to perform various further assessments by the government. Further, classifying the merchants into different categories may also be essential to determine the impact on the performance of merchants belonging to different merchant categories during financial shock events such as recession, depression, pandemic, and so on. For instance, the recent global health crises, i.e., the COVID-19 pandemic impacted the various merchants across the globe gravely, due to lockdowns and store closures. It is essential for the different governments and financial institutions to analyze this impact on the different merchant categories to determine a suitable action plan for their recovery, thus helping the GDP figures of the respective country as well. Furthermore, various consulting projects may also require the classification of merchants into different merchant categories to determine the relative performance of smaller merchants around the globe with their large merchant counterparts. Additionally, such analysis may also be performed at a smaller scale such as town, district, city, or state level.

Conventionally, merchant classification is performed by determining the merchant hierarchy of a merchant and using the determined merchant hierarchy to perform that merchant classification based on a set of predefined rules. The term ‘merchant hierarchy’ as used herein refers to a hierarchy of sub-stores under the same merchant, otherwise known as chain stores or chain merchants. For example, a pizza brand with 10 stores or branches will have a merchant hierarchy identifying all of the 10 stores as a single entity or a single merchant. In an additional example, a mom-and-pop pizza store with a single branch will be represented as a single entity as well in its merchant hierarchy. Further, herein the set of predefined rules refers to a set of static rules for classifying the merchant. For example, the set of predefined rules may suggest that a merchant may be classified as a large merchant if it has more than 5 branches and an overall revenue of over $50,000.

As may be understood, the conventional merchant classification approach poses a variety of drawbacks such as being slow and complex. It is noted that the conventional merchant classification approach fails to consider the financial and operational attributes of each merchant from the plurality of merchants that need to be classified during the classification process. Further, since it is complex to determine the merchant hierarchy for governments and financial institutions, they have to rely on the data provided by the acquiring banks associated with the plurality of merchants. However, as may be noted, it is very common for different merchants to be tagged incorrectly or differently across different acquiring banks, different regions, and so on. As a result, this different or incorrect tagging may lead to the formation of an incorrect merchant hierarchy for the plurality of merchants, which in turn will lead to incorrect merchant classification. Furthermore, since the conventional approach relies on static predefined rules for the merchant classification process, the results generated thereafter are static and fail to provide actionable insights as well.

Thus, there exists a technological need for technical solutions for improving the existing merchant classification techniques or approaches for classifying a plurality of merchants into different merchant categories.

### SUMMARY

Various embodiments of the present disclosure provide methods and systems for classifying a plurality of merchants into different merchant categories.

In an embodiment, a computer-implemented method for performing merchant classification into different merchant classes or merchant categories is disclosed. The computer-implemented method performed by a server system includes accessing a historical transaction dataset from a database associated with the server system. The historical transaction dataset includes transaction attributes corresponding to a plurality of payment transactions performed between a plurality of cardholders and a plurality of merchants. The computer-implemented method further includes generating a set of key performance features for each merchant of the plurality of merchants based, at least in part, on the historical transaction dataset. The computer-implemented method further includes determining a set of hyper-parameters for a clustering machine learning model based, at least in part, on a K-nearest neighbor (KNN) plot generated based on the set of key performance features for each merchant. In an example, the set of hyper-parameters includes an epsilon value and a Minimum points (MinPts) value. The computer-implemented method further includes generating via the clustering machine learning model, a set of merchant clusters based, at least in part, on the set of key performance features for each merchant and the set of hyper-parameters. The computer-implemented method further includes labeling each merchant cluster of the set of merchant clusters as one of a first merchant class and a second merchant class based, at least in part, on a classification threshold.

In another embodiment, a server system is disclosed. The server system includes a communication interface and a memory including executable instructions. The server system also includes a processor communicably coupled to the memory. The processor is configured to execute the instructions to cause the server system, at least in part, to access a historical transaction dataset from a database associated with the server system. The historical transaction dataset includes transaction attributes corresponding to a plurality of payment transactions performed between a plurality of cardholders and a plurality of merchants. Further, the server system is caused to generate a set of key performance features for each merchant of the plurality of merchants based, at least in part, on the historical transaction dataset. Further, the server system is caused to determine a set of hyper-parameters for a clustering machine learning model based, at least in part, on a K-nearest neighbor (KNN) plot generated based on the set of key performance features for each merchant. In an example, the set of hyper-parameters includes an epsilon value and a Minimum points (MinPts) value. Further, the server system is caused to generate via the clustering machine learning model, a set of merchant clusters based, at least in part, on the set of key performance features for each merchant and the set of hyper-parameters. Further, the server system is caused to label each merchant cluster of the set of merchant clusters as one of a first merchant class and a second merchant class based, at least in part, on a classification threshold.

In yet another embodiment, a non-transitory computer-readable storage medium is disclosed. The non-transitory computer-readable storage medium includes computer-executable instructions that, when executed by at least a processor of a server system, cause the server system to perform a method. The method includes accessing a historical transaction dataset from a database associated with the server system. The historical transaction dataset includes transaction attributes corresponding to a plurality of payment transactions performed between a plurality of cardholders and a plurality of merchants. The method further includes generating a set of key performance features for each merchant of the plurality of merchants based, at least in part, on the historical transaction dataset. The method further includes determining a set of hyper-parameters for a clustering machine learning model based, at least in part, on a K-nearest neighbor (KNN) plot generated based on the set of key performance features for each merchant. In an example, the set of hyper-parameters includes an epsilon value and a Minimum points (MinPts) value. The method further includes generating via the clustering machine learning model, a set of merchant clusters based, at least in part, on the set of key performance features for each merchant and the set of hyper-parameters. The method further includes labeling each merchant cluster of the set of merchant clusters as one of a first merchant class and a second merchant class based, at least in part, on a classification threshold.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

For a more complete understanding of example embodiments of the present technology, reference is now made to the following descriptions taken in connection with the accompanying drawings in which:

FIG. 1 illustrates an exemplary representation of an environment related to at least some example embodiments of the present disclosure;

FIG. 2 illustrates a simplified block diagram of a server system, in accordance with an embodiment of the present disclosure;

FIG. 3 illustrates a block diagram representation of an architecture of a data cleansing machine learning (ML) model, in accordance with an embodiment of the present disclosure;

FIG. 4 illustrates a block diagram representation of an architecture of a clustering ML model, in accordance with an embodiment of the present disclosure;

FIG. 5 illustrates experimental results of an experiment performed, in accordance with one or more embodiments of the present disclosure;

FIG. 6 illustrates a process flow diagram depicting a method for identifying a merchant class of a merchant, in accordance with an embodiment of the present disclosure;

FIG. 7 illustrates a process flow diagram depicting a method for performing merchant classification into different merchant classes, in accordance with an embodiment of the present disclosure;

FIG. 8 illustrates a simplified block diagram of an acquirer server, in accordance with an embodiment of the present disclosure;

FIG. 9 illustrates a simplified block diagram of an issuer server, in accordance with an embodiment of the present disclosure; and

FIG. 10 illustrates a simplified block diagram of a payment server, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification does not necessarily all refer to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, a system, a method, or a computer program product. Accordingly, embodiments of the present disclosure may take the form of an entire hardware embodiment, an entire software embodiment (including firmware, resident software, micro-code, etc.), or an embodiment combining software and hardware aspects that may all generally be referred to herein as a “circuit”, “engine”, “module”, or “system”. Furthermore, aspects of the present disclosure may take the form of a computer program product embodied in one or more computer-readable storage media having computer-readable program code embodied thereon.

The terms “account holder”, “user”, “cardholder”, “consumer”, and “buyer” are used interchangeably throughout the description and refer to a person who has a payment account or a payment card (e.g., credit card, debit card, etc.) associated with the payment account, that will be used by them at a merchant to perform a payment transaction. The payment account may be opened via an issuing bank or an issuer server.

The term “merchant”, used throughout the description generally refers to a seller, a retailer, a purchase location, an organization, or any other entity that is in the business of selling goods or providing services, and it can refer to either a single business location or a chain of business locations of the same entity.

The terms “payment network” and “card network” are used interchangeably throughout the description and refer to a network or collection of systems used for the transfer of funds through the use of cash substitutes. Payment networks may use a variety of different protocols and procedures in order to process the transfer of money for various types of transactions. Payment networks are companies that connect an issuing bank with an acquiring bank to facilitate an online payment. Transactions that may be performed via a payment network may include product or service purchases, credit purchases, debit transactions, fund transfers, account withdrawals, etc. Payment networks may be configured to perform transactions via cash substitutes that may include payment cards, letters of credit, checks, financial accounts, etc. Examples of networks or systems configured to perform or function as payment networks include those operated by such as Mastercard®.

The term “payment card”, used throughout the description, refers to a physical or virtual card linked with a financial or payment account that may be presented to a merchant or any such facility to fund a financial transaction via the associated payment account. Examples of the payment cards include, but are not limited to, debit cards, credit cards, prepaid cards, virtual payment numbers, virtual card numbers, forex cards, charge cards, e-wallet cards, and stored-value cards. A payment card may be a physical card that may be presented to the merchant for funding the payment. Alternatively, or additionally, the payment card may be embodied in the form of data stored in a user device, where the data is associated with a payment account such that the data can be used to process the financial transaction between the payment account and a merchant's financial account.

The term “payment account”, used throughout the description refers to a financial account that is used to fund a financial transaction. Examples of the financial account include, but are not limited to a savings account, a credit account, a checking account, and a virtual payment account. The financial account may be associated with an entity such as an individual person, a family, a commercial entity, a company, a corporation, a governmental entity, a non-profit organization, and the like. In some scenarios, the financial account may be a virtual or temporary payment account that can be mapped or linked to a primary financial account, such as those accounts managed by payment wallet service providers, and the like.

The terms “payment transaction”, “financial transaction”, “event”, and “transaction” are used interchangeably throughout the description and refer to a transaction or transfer of payment of a certain amount being initiated by the cardholder. More specifically, they refer to electronic financial transactions including, for example, online payment, payment at a terminal (e.g., Point Of Sale (POS) terminal), and the like. Generally, a payment transaction is performed between two entities, such as a buyer and a seller. It is to be noted that a payment transaction is followed by a payment transfer of a transaction amount (i.e., monetary value) from one entity (e.g., issuing bank associated with the buyer) to another entity (e.g., acquiring bank associated with the seller), in exchange of any goods or services. OVERVIEW

Various embodiments of the present disclosure provide methods, systems, user devices, and computer program products for performing merchant classification into different merchant classes or merchant categories.

In an embodiment, a server system that may be a payment server associated with a payment network or an acquirer server is configured to access a historical transaction dataset from a database associated with the server system. Herein, the historical transaction dataset includes transaction attributes corresponding to a plurality of payment transactions performed between a plurality of cardholders and a plurality of merchants. Thereafter, the server system is configured to generate a set of key performance features for each merchant of the plurality of merchants based, at least in part, on the historical transaction dataset. In particular, the server system is configured to determine via a data cleansing machine learning (ML) model, a root word for each merchant of the plurality of merchants based, at least in part, on the historical transaction dataset. In a non-limiting example, the data cleansing ML model is a Natural Language Processing (NLP)-based ML model. Then, the server system determines a plurality of merchant hierarchies present in the plurality of merchants based, at least in part, on the root word determined for each merchant. Thereafter, the server system generates the set of key performance features for each merchant hierarchy of the plurality of merchant hierarchies based, at least in part, on the historical transaction dataset. Further, the server system is configured to normalize each key performance feature of the set of key performance features based, at least in part, on a Minimum-Maximum (Min-Max) scaling process.

In another embodiment, the server system is configured to generate a K-nearest neighbor (KNN) plot based on the set of key performance features for each merchant. In particular, the server system may generate an estimated KNN plot based, at least in part, on the KNN plot. Then, the server system is configured to determine a slope of the estimated KNN plot and determine the set of the hyper-parameters including an epsilon value and a Minimum points (MinPts) value based, at least in part, on the slope of the estimated KNN plot.

In another embodiment, the server system is configured to generate, via a clustering ML model, a set of merchant clusters based, at least in part, on the set of key performance features for each merchant and the set of hyper-parameters. In a non-limiting example, the clustering ML model is a Density-Based Spatial Clustering of Applications with Noise (DBSCAN)-based ML model.

In particular, for generating the set of merchant clusters via the clustering ML model, the server system is further configured to generate a feature vector for each merchant of the plurality of merchants in a feature space based, at least in part, on the set of key performance features. Herein, each feature vector indicates a spatial representation of an individual merchant from the plurality of merchants in the feature space. Then, the server system initializes a first cluster, the first cluster being an empty cluster. Then, the server system selects a merchant from the plurality of merchants arbitrarily. Then, the server system determines if the feature vector of the merchant is a core point based, at least in part, on the epsilon value and the MinPts value. Then, in response to determining that the feature vector of the merchant is the core point, the server system adds the merchant to the first cluster. Then, the server system determines a neighborhood for the merchant based, at least in part, on the epsilon value. Further, the server system performs a set of operations for each merchant in the neighborhood of the merchant.

The set of operations includes adding the feature vector corresponding to each merchant in the neighborhood of the merchant to the first cluster. Then, the set of operations includes determining a secondary neighborhood for the feature vector corresponding to each merchant in the neighborhood of the merchant based, at least in part, on the epsilon value. Then, the set of operations includes adding each feature vector corresponding to each merchant in the secondary neighborhood to the first cluster. It is noted that the set of operations is performed iteratively for feature vectors corresponding to the plurality of merchants till no additional merchant can be added to the first cluster. Further, the server system initializes a second cluster, the second cluster being a noise cluster, and adds the feature vectors corresponding to merchants outside the first cluster to the second cluster. In other words, the server system is configured to generate via the clustering ML model, a noise cluster, i.e., the second cluster based, at least in part, on the set of key performance features for each merchant and the set of hyper-parameters. In another embodiment, the server system is configured to determine a classification threshold based, at least in part, on the noise cluster.

In another embodiment, the server system is configured to label each merchant cluster of the set of merchant clusters as one of a first merchant class and a second merchant class based, at least in part, on the classification threshold.

Various embodiments of the present disclosure provide multiple advantages and technical effects while addressing technical problems such as how to classify merchants into different merchant classes or merchant categories. To that end, the various embodiments of the present disclosure provide an approach for performing merchant classification into different merchant classes or merchant categories. It is noted that the approach of the present disclosure uses a data cleansing machine learning (ML) model to clean the merchant's name by determining the root word for each merchant. Then, this root word is used to determine a plurality of merchant hierarchies present within the plurality of merchants. It is noted this aspect of the present disclosure enables correct aggregation of merchant-related features for each merchant hierarchy thereby, leading to the correct classification of the merchant into different merchant categories or classes.

Further, the present disclosure describes the use of a clustering ML model, i.e., a DBSCAN ML model to form merchant clusters in an efficient manner using a feature vector corresponding to each merchant in the feature space. It is noted that since the feature vector is generated using the set of key performance features, the overall feature vector, i.e., generated feature vector is dynamic in nature. In other words, the input of the DBSCAN ML model is dynamic in nature which leads to the efficient classification of merchants into the different merchant classes. Furthermore, the insights generated by the DBSCAN ML model are highly actionable due to their generation based on the feature vector.

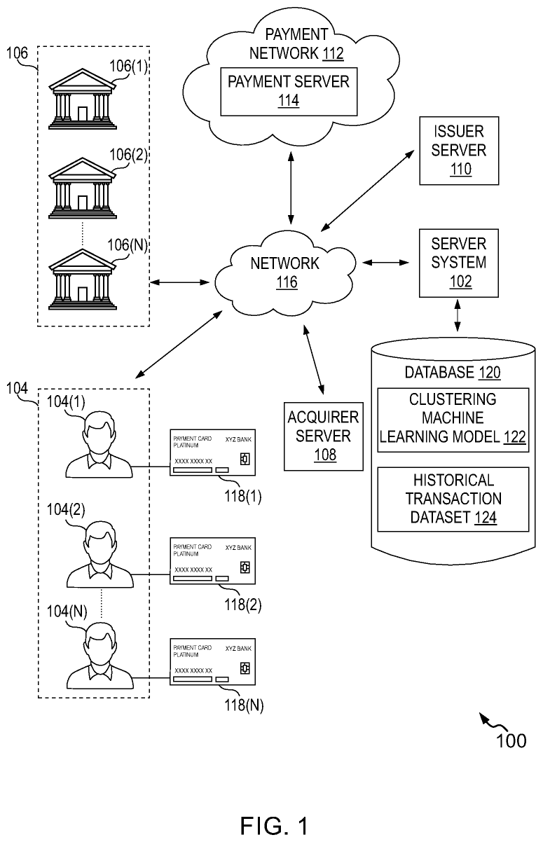

Various embodiments of the present disclosure are described hereinafter with reference to FIGS. 1 to 10.

FIG. 1 illustrates a representation of an environment 100 related to at least some embodiments of the present disclosure. Although the environment 100 is presented in one arrangement, other embodiments may include the parts of the environment 100 (or other parts) arranged otherwise depending on, for example, cleansing historical transaction data to determine merchant hierarchies, determining hyper-parameters of a clustering machine learning (ML) model, generating a set of merchant clusters using the clustering ML model, labeling each merchant cluster of the set of merchant cluster as one of either a first merchant class or a second merchant class, and the like

The environment 100 generally includes a plurality of entities such as a server system 102, a plurality of cardholders 104(1), 104(2), . . . 104(N) (collectively, referred to as a plurality of cardholders 104 and ‘N’ is a Natural number), a plurality of merchants 106(1), 106(2), . . . 106(N) (collectively, referred to as a plurality of merchants 106 and ‘N’ is a Natural number), an acquirer server 108, an issuer server 110, and a payment network 112 including a payment server 114, each coupled to, and in communication with (and/or with access to) a network 116. The network 116 may include, without limitation, a Light Fidelity (Li-Fi) network, a Local Area Network (LAN), a Wide Area Network (WAN), a Metropolitan Area Network (MAN), a satellite network, the Internet, a fiber optic network, a coaxial cable network, an Infrared (IR) network, a Radio Frequency (RF) network, a virtual network, and/or another suitable public and/or private network capable of supporting communication among two or more of the parts or users illustrated in FIG. 1, or any combination thereof.

Various entities in the environment 100 may connect to the network 116 in accordance with various wired and wireless communication protocols, such as Transmission Control Protocol/Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, future communication protocols or any combination thereof. For example, the network 116 may include multiple different networks, such as a private network made accessible by the server system 102 and a public network (e.g., the Internet, etc.) through which the server system 102, the acquirer server 108, the issuer server 110, and the payment server 114 may communicate.

In an embodiment, the plurality of cardholders 104 use one or more payment cards 118(1), 118(2), . . . 118(N) (collectively, referred to hereinafter as a plurality of payment cards 118 and ‘N’ is a Natural number) respectively to make payment transactions. The cardholder (e.g., the cardholder 104(1)) may be any individual, representative of a corporate entity, anon-profit organization, or any other person who is presenting payment account details during an electronic payment transaction. The cardholder (e.g., the cardholder 104(1)) may have a payment account issued by an issuing bank (not shown in figures) associated with the issuer server 110 (explained later) and may be provided a payment card (e.g., the payment card 118(1)) with financial or other account information encoded onto the payment card (e.g., the payment card 118(1)) such that the cardholder (i.e., the cardholder 104(1)) may use the payment card 118(1) to initiate and complete a payment transaction using a bank account at the issuing bank.

In an example, the plurality of cardholders 104 may use their corresponding electronic devices (not shown in figures) to access a mobile application or a website associated with the issuing bank, or any third-party payment application. In various non-limiting examples, electronic devices may refer to any electronic devices such as, but not limited to, Personal Computers (PCs), tablet devices, Personal Digital Assistants (PDAs), voice-activated assistants, Virtual Reality (VR) devices, smartphones, and laptops.

In an embodiment, the plurality of merchants 106 may include retail shops, restaurants, supermarkets or establishments, government and/or private agencies, or any such places equipped with POS terminals, where a cardholder such as the cardholder 104(1) visits for performing the financial transaction in exchange for any goods and/or services or any financial transactions. It is understood that the plurality of merchants 106 can be divided or classified generally into two or three different classes such as a small/medium merchant class and a large merchant class. The term ‘small merchant class’ may represent a group of merchants from the plurality of merchants 106 that have a small number of employees and a low annual turnover for sales when compared to a medium merchant class. The term ‘medium merchant class’ may represent a group of medium size enterprises or merchants from the plurality of merchants 106 that have more employees and a higher annual turnover of sales than the small merchant class but lower than a large merchant class. The term ‘large merchant class’ may represent a group of large-scale enterprises, corporations, or merchants from the plurality of merchants 106 that have thousands of employees and hundreds of millions or billions of dollars worth of annual turnover of sales.

In one scenario, the plurality of cardholders 104 may use their corresponding payment accounts to conduct payment transactions with the plurality of merchants 106. Moreover, it may be noted that each of the plurality of cardholders 104 may use their corresponding payment card (such as the payment card 118(1)) from the plurality of payment cards 118 differently or make the payment transaction using different means of payment such as net banking, Unified Payments Interface (UPI), cash, etc. For instance, the cardholder 104(1) may enter payment account details on an electronic device (not shown) associated with the cardholder 104(1) to perform an online payment transaction. In another example, the cardholder 104(2) may utilize the payment card 118(2) to perform an offline payment transaction. It is understood that generally, the term “payment transaction” refers to an agreement that is carried out between a buyer and a seller to exchange goods or services in exchange for assets in the form of a payment (e.g., cash, fiat currency, digital asset, cryptographic currency, coins, tokens, etc.). For example, the cardholder 104(3) may enter details of the payment card 118(3) to transfer funds in the form of fiat currency on an e-commerce platform to buy goods. In another instance, each cardholder (e.g., the cardholder 104(1)) of the plurality of cardholders 104 may transact at any merchant (e.g., the merchant 106(1)) from the plurality of merchants 106.

In one embodiment, the plurality of cardholders 104 may be associated with financial institutions such as issuing banks who are associated with the issuer server 110. To that end, it is noted that the terms “issuer bank”, “issuing bank” or simply “issuer”, and “issuer servers”, hereinafter may be used interchangeably. It may be understood that a cardholder (e.g., the cardholder 104(1)) may have a payment account with the issuing bank, (which also issues a payment card, such as a credit card or a debit card to the plurality of cardholders 104). Further, the issuing banks provide microfinance banking services (e.g., payment transactions using credit/debit cards) for processing electronic payment transactions, to the cardholder (e.g., the cardholder 104(1)).

In an embodiment, the plurality of merchants 106 is associated with financial institutions such as acquiring banks who are associated with the acquirer server 108. To that end, it is noted that the terms “acquirer”, “acquiring bank”, “acquiring bank” or “acquirer server” will be used interchangeably hereinafter. In an embodiment, each merchant (e.g., the merchant 106(1)) is associated with an acquirer server (e.g., the acquirer server 108). In one embodiment, the acquirer server 108 is associated with a financial institution (e.g., a bank) that processes financial transactions for the merchant 106(1). This can be an institution that facilitates the processing of payment transactions for physical stores, merchants (e.g., the merchant 106(1)), or institutions that own platforms that make either online purchases or purchases made via software applications possible (e.g., shopping cart platform providers and in-app payment processing providers).

As explained earlier, conventionally merchant classification is performed by determining a merchant hierarchy of a merchant and using the determined merchant hierarchy to perform that merchant classification based on a set of predefined rules. As may be understood, the conventional merchant classification approach poses a variety of drawbacks such as being slow and complex. It is noted that the conventional merchant classification approach fails to consider the financial and operational attributes of each merchant from the plurality of merchants 106 that need to be classified during the classification process. Further, since it is complex to determine the merchant hierarchy for governments and financial institutions, they have to rely on the data provided by the acquiring banks through the acquirer server 108 associated with the plurality of merchants 106. However, as may be noted, it is very common for different merchants to be tagged incorrectly or differently across different acquiring banks, different regions, and so on. As a result, this different or incorrect tagging may lead to the formation of an incorrect merchant hierarchy for the plurality of merchants, which in turn will lead to incorrect merchant classification. Furthermore, since the conventional approach relies on static predefined rules for the merchant classification process, the results generated thereafter are static and fail to provide actionable insights as well.

The above-mentioned technical problem among other problems is addressed by one or more embodiments implemented by the server system 102 of the present disclosure. In one embodiment, the server system 102 is configured to perform one or more of the operations described herein.

In one embodiment, the environment 100 may further include a database 120 coupled with the server system 102. In an example, the server system 102 coupled with the database 120 is embodied within the payment server 114, however, in other examples, the server system 102 can be a standalone component (acting as a hub) connected to the acquirer server 108 and the issuer server 110. The database 120 may be incorporated in the server system 102 or maybe an individual entity connected to the server system 102 or maybe a database stored in cloud storage. In one embodiment, the database 120 may store a clustering machine learning (ML) model 122, a historical transaction dataset 124, and other necessary machine instructions required for implementing the various functionalities of the server system 102 such as firmware data, operating system, and the like.

In an example, the database 120 stores the historical transaction dataset 124 which may also include historical transaction data of the plurality of cardholders 104 and the plurality of merchants 106. The historical transaction data may include, but is not limited to, transaction attributes, such as transaction amount, source of funds such as bank accounts, debit cards or credit cards, transaction channel used for loading funds such as POS terminal or ATM, transaction velocity features such as count and transaction amount sent in the past ‘x’ number of days to a particular user, transaction location information, external data sources, merchant country, merchant Identifier (ID), cardholder ID, cardholder product, cardholder Permanent Account Number (PAN), Merchant Category Code (MCC), merchant location data or merchant co-ordinates, merchant industry, merchant super industry, ticket price, and other transaction-related data.

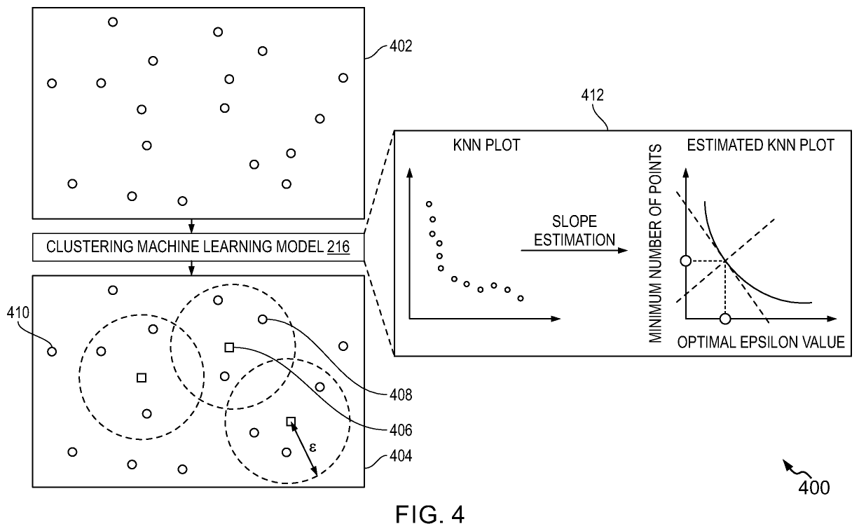

In another example, the clustering ML model 122 is an AI or ML-based model that is configured or trained to perform a plurality of operations. In a non-limiting example, the clustering ML model 122 can be a Density-Based Spatial Clustering of Applications with Noise (DBSCAN)-based ML model. It is noted that the clustering ML model 122 has been explained in detail later in the present disclosure with reference to FIG. 4. In addition, the database 120 provides a storage location for data and/or metadata obtained from various operations performed by the server system 102.

In an embodiment, the server system 102 is configured to access a historical transaction dataset 124 from a database such as the database 120 associated with the server system 102. It is noted that the historical transaction dataset 124 includes information related to a plurality of entities within the payment network 112. As described earlier, the historical transaction dataset 124 includes transaction attributes corresponding to a plurality of payment transactions between the plurality of cardholders 104 and the plurality of merchants 106. Then, the server system 102 is configured to generate a set of key performance features for each merchant of the plurality of merchants based, at least in part, on the historical transaction dataset 124. In a non-limiting example, the set of key performance features may include operation data-related features, spend-related features, transaction-related features, and the like.

Thereafter, the server system 102 is configured to generate a K-nearest neighbor (KNN) plot based, at least in part, on the set of key performance features for each merchant of the plurality of merchants 106. This aspect has been described in detail further in the present disclosure. Then, the server system 102 is configured to determine a set of hyper-parameters for the clustering ML model 122 based, at least in part, on the KNN plot. It is noted that for a DBSCAN-based ML model, the hyper-parameters may include at least an epsilon value and a Minimum Points (MinPts) value. Further, the server system 102 is configured to generate a set of merchant clusters based, at least in part, on the set of key performance features for each merchant and the set of hyper-parameters. In an example, an AI or ML model may be used for generating the set of merchant clusters. In a non-limiting implementation, the clustering ML model 122 is used for generating the set of merchant clusters based, at least in part, on the set of key performance features for each merchant and the set of hyper-parameters.

Furthermore, the server system 102 is configured to label each merchant cluster of the set of merchant clusters as one of a first merchant class and a second merchant class based, at least in part, on a classification threshold. It is noted that this aspect has been described in detail later in the present disclosure. In a non-limiting example, the first merchant class may be a small merchant class and the second merchant class may be a large merchant class. In an embodiment, the classification threshold may be derived from a noise cluster determined using the clustering ML model 122 through a process described later in the present disclosure.

It is understood that since the set of key performance features is generated using the transaction attributes that are dynamic in nature (since they capture or represent information regarding the transaction data over a predefined time period), the set of clusters being generated is more precise. This aspect enables improved performance while labeling the clusters with their respective merchant class. As may be noted, the clustering ML model 122 being a DBSCAN-based ML model is able to segregate noisy merchants from a set of merchants. As may be understood, merchants belonging to the large merchant class are lower in number in the real world when compared with the number of merchants belonging to the small or medium merchant class. To that end, the DBSCAN-based ML model may directly segregate the merchants belonging to the large merchant class as the noisy cluster while keeping merchants belonging to the small or medium merchant class in a separate cluster. These clusters may then be labeled by the server system 102 with their respective class labels to complete the merchant classification process. Upon completion of the classification, the server system 102 may then perform secondary operations such as, but not limited to, determining the performance of each merchant class, computing the Small Minus Big (SMB) performance index, determining industry-level insights using data associated with the merchants from their corresponding merchant classes, determining geographical pain points for small, medium, or large merchant classes, tracking the performance of merchants across industries, areas or regions, and the like.

In one embodiment, the payment network 112 may be used by the payment card issuing authorities as a payment interchange network. Examples of the plurality of payment cards 118 include debit cards, credit cards, etc. Similarly, examples of payment interchange networks include but are not limited to, a Mastercard® payment system interchange network. The Mastercard® payment system interchange network is a proprietary communications standard promulgated by Mastercard International Incorporated® for the exchange of electronic payment transaction data between issuers and acquirers that are members of Mastercard International Incorporated®. (Mastercard is a registered trademark of Mastercard International Incorporated located in Purchase, N.Y.).

It should be understood that the server system 102 is a separate part of the environment 100, and may operate apart from (but still in communication with, for example, via the network 116) any third-party external servers (to access data to perform the various operations described herein). However, in other embodiments, the server system 102 may be incorporated, in whole or in part, into one or more parts of the environment 100.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device is shown in FIG. 1 may be implemented as multiple, distributed systems or devices. In addition, the server system 102 should be understood to be embodied in at least one computing device in communication with the network 116, which may be specifically configured, via executable instructions, to perform steps as described herein, and/or embodied in at least one non-transitory computer-readable media.

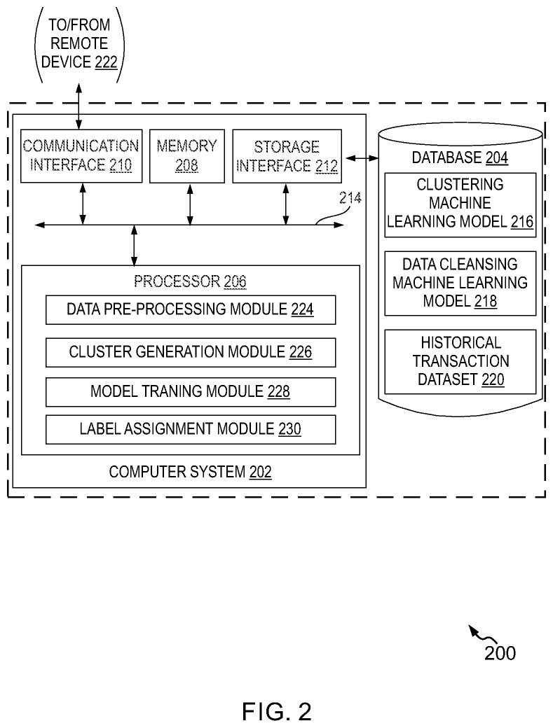

FIG. 2 illustrates a simplified block diagram of a server system 200, in accordance with an embodiment of the present disclosure. It is noted that the server system 200 is identical to the server system 102 of FIG. 1. In one embodiment, the server system 200 is a part of the payment network 112 or integrated within the payment server 114. In some embodiments, the server system 200 is embodied as a cloud-based and/or Software as a Service (SaaS) based architecture.

The server system 200 includes a computer system 202 and a database 204. It is noted that the database 204 is identical to the database 120 of FIG. 1. The computer system 202 includes at least one processor 206 (herein, referred to interchangeably as ‘processor 206’) for executing instructions, a memory 208, a communication interface 210, and a storage interface 212 that communicates with each other via a bus 214.

In some embodiments, the database 204 is integrated into the computer system 202. For example, the computer system 202 may include one or more hard disk drives as the database 204. A storage interface 212 is any component capable of providing the processor 206 with access to the database 204. The storage interface 212 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In one non-limiting example, the database 204 is configured to store a clustering machine learning (ML) model 216, a data cleansing ML model 218, a historical transaction dataset 220, and the like. It is noted that the clustering ML model 216 is identical to the clustering ML model 122 of FIG. 1. Further, it is noted that the historical transaction dataset 124 of FIG. 1 is identical to the historical transaction dataset 220.

As may be understood, although the various embodiments of the invention described herein are explained with the help of examples from the payment ecosystem, the same should not be construed as a limitation and other suitable implementations of the novel approach described herein can be applied to other technical fields as well such as, but not limited to, image processing, medical industry and the like. To that end, although the historical transaction dataset 220 is considered to include transaction-related data for a financial sector-related implementation, the same may also include image-related data, medical records-related data, and the like based on suitable applications/implementations.

The processor 206 includes suitable logic, circuitry, and/or interfaces to execute operations for determining a plurality of merchant hierarchies using the historical transaction dataset 220, classifying merchants into different classes, and the like. In other words, the processor 206 includes suitable logic, circuitry, and/or interfaces to execute operations for labeling the merchants with different class labels and the like. Examples of the processor 206 include, but are not limited to, an Application-Specific Integrated Circuit (ASIC) processor, a Reduced Instruction Set Computing (RISC) processor, a Graphical Processing Unit (GPU), a Complex Instruction Set Computing (CISC) processor, a Field-Programmable Gate Array (FPGA), and the like.

The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the server system 200, as described herein. In another embodiment, the memory 208 may be realized in the form of a database server or a cloud storage working in conjunction with the server system 200, without departing from the scope of the present disclosure.

The processor 206 is operatively coupled to the communication interface 210, such that the processor 206 is capable of communicating with a remote device 222 such as the acquirer server 108, the issuer server 110, the payment server 114, or communicating with any entity connected to the network 116 (as shown in FIG. 1).

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one implementation, the processor 206 includes a data pre-processing module 224, a cluster generation module 226, a model training module 228, and a label assignment module 230. It should be noted that components, described herein, such as the data pre-processing module 224, the cluster generation module 226, the model training module 228 and, the label assignment module 230 can be configured in a variety of ways, including electronic circuitries, digital arithmetic, and logic blocks, and memory systems in combination with software, firmware, and embedded technologies.

In an embodiment, the data pre-processing module 224 includes suitable logic and/or interfaces for accessing a historical transaction dataset such as the historical transaction dataset 220 from a database such as the database 204 associated with the server system 200. In one implementation, the historical transaction dataset 220 may include transaction attributes corresponding to a plurality of payment transactions performed between the plurality of cardholders 104 and the plurality of merchants 106. In some scenarios, the transaction attributes may include any merchant-related data accessed from the acquirer server 108. It is noted that this non-limiting example is specific to the financial industry or payment ecosystem. To that end, the historical transaction dataset 220 can be configured to include different information specific to any field of operation. Therefore, it is understood that the various embodiments of the present disclosure apply to a variety of different fields of operation and the same is covered within the scope of the present disclosure.

Returning to the previous example, the plurality of historical payment transactions may be performed within a predetermined interval of time (e.g., 6 months, 12 months, 24 months, etc.). In some other non-limiting examples, the historical transaction dataset 220 includes information related to at least merchant name identifier, unique merchant identifier, timestamp information (i.e., transaction date/time), geo-location related data (i.e., latitude and longitude of the cardholder/merchant), Merchant Category Code (MCC), merchant industry, merchant super industry, information related to payment instruments involved in the set of historical payment transactions, cardholder identifier, Permanent Account Number (PAN), merchant database (DBA) name, country code, transaction identifier, transaction amount, and the like.

In another embodiment, the historical transaction dataset 220 may include information related to past payment transactions such as transaction date, transaction time, geo-location of a transaction, transaction amount, transaction marker (e.g., fraudulent or non-fraudulent), and the like. In yet another embodiment, the historical transaction dataset 220 may include information related to the acquirer server 108 such as the date of merchant registration with the acquirer server 108, amount of payment transactions performed at the acquirer server 108 in a day, number of payment transactions performed at the acquirer server 108 in a day, maximum transaction amount, minimum transaction amount, number of fraudulent merchants or non-fraudulent merchants registered with the acquirer server 108, and the like. It is noted that all the various types of information within the historical transaction dataset 220 may be called transaction attributes.

In addition, the data pre-processing module 224 is configured to generate a set of key performance features for each merchant of the plurality of merchants 106 based, at least in part, on the historical transaction dataset 220. In various non-limiting examples, the set of key performance features may at least include features such as revenue per cardholder, number of cardholders served, number of active merchant stores, number of postal presence, annual transaction value, annual transactions number, cross border transaction value, the share of domestic to cross border transaction value, the share of card present transactions, the share of card-not-present transactions, the share of credit to debit transaction value, average store footfall, transactions without a card (i.e., payment card), the value of credit transactions, value of sales per merchant store, and average ticket price. The different features from the set of key performance features enable the server system 200 to gauge the various operational and functional attributes associated with each merchant from the plurality of merchants 106. In some scenarios, few features may be more relevant than other features. The average store footfall feature is a measure of buyers (i.e., cardholders) who make purchases in-store. It is understood that large merchants will have a higher average store footfall than small merchants. The average ticket price feature is the average amount that a buyer spends on an item at the merchant. This feature varies between different merchant industries. For instance, in the fashion industry, larger merchants tend to have a far greater average ticket price than small merchants whereas this difference is less profound in industries such as the food industry. The annual number of buyers and annual transaction number feature both give an estimate of merchant revenue and therefore, only one of these features may be selected as a key performance feature.

More specifically, it is understood that many merchants from the plurality of merchants 106 may be related to each other in a way that they are operated by the same entity, organization, or corporation. In other words, many merchants may belong to a chain of stores or a chain of merchants. A few examples of well-known chains of merchants are Walmart®, McDonald's®, Subway®, Target®, and the like. To that end, it is essential to collate these different merchant stores together into a single merchant hierarchy before key performance features are computed to give a more accurate picture of such a chain of merchants. However, there exists a problem in determining a merchant hierarchy from the historical transaction dataset 220.

As may be understood, acquirer-reported data, i.e., the merchant-related data is often messy in nature and does not capture all merchant branches or stores that are part of the same parent merchant or chain. Further, it is also possible that different POS terminals present at the same merchant may report data differently, leading to such POS terminals being confusing for humans who might report such POS terminals to belong to a different merchant while filling the required documentation or forms at the acquirer's end. This confusion may take place due to the presence of special characters, and abbreviations, among other commonly used words for merchant names in the reported merchant DBA name. For example, the ABC chain of merchants may have stores in two different cities whose POS terminals may identify them as ‘ABC store IN’ and ABC store OH’. Therefore, even if the merchant's ABC store IN and ABC store OH belong to the same chain of merchants, they may be thought to be different merchants during conventional classification approaches that rely on the reported names to perform their classification process leading to incorrect classification.

This problem is addressed by the data pre-processing module 224 by determining a root word by analyzing the reported merchant DBA name and then forming the merchant hierarchies based on the determined root word. In particular, the data pre-processing module 224 determines using the data cleansing ML model 218, a root word for each merchant of the plurality of merchants 106 based, at least in part, on the historical transaction dataset 220. Then, the data pre-processing module 224 determines a plurality of merchant hierarchies present in the plurality of merchants 106 based, at least in part, on the root word determined for each merchant of the plurality of merchants 106. Thereafter, the data pre-processing module 224 generates the set of key performance features for each merchant hierarchy of the plurality of merchant hierarchies based, at least in part, on the historical transaction dataset 220. As may be understood, by generating the set of key performance features for each merchant hierarchy, the information captured or represented by these features for the entire merchant hierarchy is more accurate and precise. In a non-limiting example, the data cleansing ML model 218 is a Natural Language Processing (NLP)-based ML model.

In another embodiment, the data pre-processing module 224 is configured to normalize each key performance feature of the set of key performance features based, at least in part, on a normalizing technique. The normalization of key performance features is done to ensure that the magnitude of these features becomes comparable. In other words, the normalization of features is done to account for differences in the magnitude of each key performance feature from the set of key performance features. For instance, the average ticket size (or price) at a merchant may range from $1 to $10,000 depending on the merchant, and another feature such as the number of visits per day by buyers may have a relatively small range such as 1 to 10. It is noted that these differences in magnitude can lead to spurious results while performing the modeling process (described later). In order to prevent this, different normalizing techniques may be used. In an instance, a Minimum-Maximum (Min-Max) scaling process may be used for normalizing each key performance feature of the set of key performance features. This Min-Max scaling process may scale the magnitude of each feature between the values of 0 to 1. In a non-limiting example, the following equation may be used to perform the Min-max scaling process:

$${X}_{SC} = \frac{X - {X}_{min}}{{X}_{max} - {X}_{min}} \qquad Eqn . 1$$

Herein, X is the feature value that has to be scaled, X_{SC} is the scaled or normalized feature value, Xₘᵢₙ is the minimum magnitude value for the feature, and Xₘₐₓ is the maximum magnitude value for the feature.

In another embodiment, the data pre-processing module 224 is communicably coupled to the cluster generation module 226 and is configured to transmit the set of key performance features for each merchant of the plurality of merchant 106 to the cluster generation module 226.

In an embodiment, the cluster generation module 226 includes suitable logic and/or interfaces for generating a set of merchant clusters based, at least in part, on the set of key performance features for each merchant of the plurality of merchants 106. Herein, each merchant cluster is generated such that it will include merchants of the same or similar merchant class. In a non-limiting example, an AI or ML model such as the clustering ML model 216 may be used for generating the set of merchant clusters. In a non-limiting implementation, the clustering ML model 216 may be a DBSCAN-based ML model (referred to hereinafter as the DBSCAN model). As may be understood, in order to operate the DBSCAN model, the cluster generation module 226 has to determine a set of hyper-parameters for the DBSCAN model.

To determine the set of hyper-parameters, the cluster generation module 226 is configured to generate a KNN plot based, at least in part, on the set of key performance features for each merchant. Then, the cluster generation module 226 is configured to generate an estimated KNN plot based, at least in part, on the KNN plot. Thereafter, the cluster generation module 226 is configured to determine a slope of the estimated KNN plot. Herein, the term ‘slope’ is the measure of steepness or the gradient of a line in a graph. It is understood that slope is a well-known term used in geometry therefore, the same is not explained further here. Further, the cluster generation module 226 is configured to determine the set of hyper-parameters based, at least in part, on the slope of the estimated KNN plot. In a non-limiting example, the set of hyper-parameters may include at least an epsilon value and a Minimum points (MinPts) value. In a particular implementation, the cluster generation module 226 may determine or compute the approximate epsilon value and approximate MinPts values from the estimated KNN plot by calculating the slope of the estimated KNN plot and determining the point where the slope of the KNN plot is close to 1. This aspect has been described further with reference to FIG. 4 later in the present disclosure.

In another embodiment, the cluster generation module 226 is configured to generate, via the clustering ML model 216, the set of merchant clusters based, at least in part, on the set of key performance features for each merchant and the set of hyper-parameters. As may be understood, the cluster generation module 226 being a DBSCAN model, is able to filter out noise from the input data. In this implementation, since the plurality of merchants 106 may include millions of merchants out of which only a handful of merchants will belong to the large merchant class. Therefore, the DBSCAN model can filter the merchants from the large merchant class from the plurality of merchants 106 as a noise cluster while forming another cluster with merchants belonging to the small or medium merchant class. In other words, the clustering ML model 216 is configured to generate a noise cluster based, at least in part, on the set of key performance features for each merchant and the set of hyper-parameters. The noise cluster may include a set of merchants belonging to the large merchant class. The process for generating the set of merchant clusters has been described in detail later in the present disclosure with reference to FIG. 4. In some scenarios, the cluster generation module 226 may further be configured to determine a classification threshold based, at least in part, on the noise cluster. For instance, the classification threshold may be derived by the cluster generation module 226 from the noise cluster (also known as cluster-0) from the DBSCAN model. In one example, the classification threshold determined for annual sales is the 90^{th} percentile value for the noise cluster.

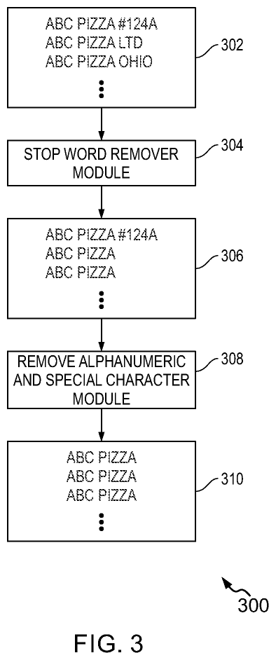

It is understood that both the clustering ML model 216 and the data cleansing ML model 218 are examples of AI or ML models. To that effect, these models have to be trained and validated before they are deployed for operation by the cluster generation module 226 or the data pre-processing module 224 to perform the variety of tasks/operations described herein. To that end, the model training module 228 includes suitable logic and/or interfaces for training or generating the data cleansing ML model 218 and the clustering ML model 216. It is noted that the detailed explanation for generating and training these models has been described later with reference to FIG. 3 and FIG. 4, respectively.

In another embodiment, the cluster generation module 226 is communicably coupled to the label assignment module 230 and is configured to transmit the set of merchant clusters to the label assignment module 230.

In an embodiment, the label assignment module 230 includes suitable logic and/or interfaces for labeling each merchant cluster of the set of merchant clusters as one of a first merchant class or a second merchant class based, at least in part, on the classification threshold. In a non-limiting example, the first merchant class may refer to the small merchant class or medium merchant class and the second merchant class may refer to the large merchant class. In particular, the label assignment module 230 may determine the overall performance of each merchant cluster and compare their performance with the classification threshold. If the performance for the merchant cluster is lower than the classification threshold, the same may be labeled as the first merchant class. On the other hand, if the performance for the merchant cluster is at least equal (i.e., equal or greater) than the classification threshold, the same may be labeled as the second merchant class.

FIG. 3 illustrates a block diagram representation 300 of an architecture of a data cleansing ML model such as the data cleansing ML model 218, in accordance with an embodiment of the present disclosure.

As described earlier, the merchant-related data is often obtained from various acquirer banks from their corresponding acquirer servers. This merchant-related data is generally not well recorded, i.e., it is often messy and does not successfully capture all merchant branches or stores that are part of the same merchant chain/hierarchy. This problem may occur since different merchant branches of the same merchant chain/hierarchy may report them using slightly different merchant names (also known as merchant DBA names). For instance, two different merchants of the same pizza chain may report their names as ‘ABC PIZZA #124A’ and ABC PIZZA LTD’. To that end, if the plurality of merchants 106 is classified based on this messy merchant-related data, the overall results of the classification task will be incorrect since individual merchants may appear to be a small merchant due to their corresponding feature vectors to the clustering ML model 216, even if these individual merchants may belong to a large merchant chain.

In order to address this problem, the data cleansing ML model 218 is configured to perform data cleansing on the historical transaction dataset 220 (which further includes the merchant-related data as well) to determine or identify merchant stores or branches belonging to the same merchant chain or hierarchy. For instance, the data cleansing ML model 218 is an NLP-based model.

As illustrated in FIG. 3, the architecture of the data cleansing ML model 218 includes a stop word remover module (see, 304) and a remove alphanumeric and special character module (see, 308). The data cleansing process starts by identifying, using the NLP model, a root word for each merchant of the plurality of merchants 106 in the historical transaction dataset 220. The goal of identifying root words is to find merchants with names similar to each other. Thereafter, the merchants with similar names are segregated into a separate list. In the illustrated example, a list of merchants (see, 302) including merchants with names such as ABC PIZZA #124, ABC PIZZA LTD, ABC PIZZA OHIO, and so on can be generated by the data cleansing ML model 218. This list of merchants 302 is fed to the stop word remover module 304. The stop word remover module 304 is configured to identify and remove stop words from the names of merchants. The term ‘stop words’ refers to words that are considered to be of little importance with the name of merchants. It is noted that a set of stop words can be configured as per the present application, i.e., to clean merchant names. For instance, the set of stop words may include ‘limited’ or ‘LTD’, ‘organization’ or ‘ORG’, city names, country names, the, and the like. The set of stop words can be generated by the data cleansing ML model 218 based, at least in part, on analyzing the names of the plurality of merchants 106 in the payment network 116. In some instances, an administrator (not shown) associated with the server system 200 may provide the set of stop words to the data cleansing ML model 218. In other words, the set of stop words may be predefined. The stop word remover module 304 of the data cleansing ML model 218 is configured to identify and remove the set of stop words from the list of merchants 302 to generate a processed list of merchants (see, 306). To that end, the stop word remover module 304 reduces the noise and lowers the dimensionality of the list of merchants 302.

Further, the processed list of merchants 306 is fed to the remove alphanumeric and special character module 308. The remove alphanumeric and special character module 308 is configured to remove alphanumeric and special characters from the processed list of merchants 306. In an instance, the remove alphanumeric and special character module 308 utilizes the regular expressions (regex) algorithm to clean the names of the merchants. It is understood that regex is used to remove unwanted characters, normalize characters, remove tags, and so on from a provided dataset. To that end, the remove alphanumeric and special character module 308 utilizes regex to generate a clean list of merchants (see, 310). It is noted from the illustrated example, that the clean list of merchants 310 includes a list of merchants with clean names. It is noted the data cleansing process is performed for the merchant names of the plurality of merchants 106 then, the data cleansing ML model 218 will be used to clean the names of the plurality of merchants 106. Upon cleaning the names of the plurality of merchants 106, the server system 200 can extract the list of merchants with the same merchant names to segregate the plurality of merchants 106. For instance, all merchants with names corresponding to ABC PIZZA can be segregated into the same list, while merchants with another name such as BCD PIZZA can be segregated into a separate list. As may be understood, each such list of merchants with the same cleaned names represents a set of merchants belonging to the same merchant hierarchy or chain. To that end, the server system 200 can utilize the data cleansing ML model 218 to determine a plurality of merchant hierarchies present in the plurality of merchants 106 based, at least in part, on cleaning the names of the plurality of merchants 106.

FIG. 4 illustrates a block diagram representation 400 of an architecture of a clustering ML model such as the clustering ML model 216, in accordance with an embodiment of the present disclosure.

As may be understood, one way of thinking about the problem of classifying merchants into different merchant classes such as a small merchant class and a large merchant class can be to think of it as a problem of removing noise from the data. Since, logically, there have to be a lot more merchants belonging to the small merchant class than those belonging to the large merchant class in any industry. So the problem is to separate large merchants (i.e., noise) from the cluster of small merchants.

In order to achieve this categorization between noise and the remaining data, the clustering ML model 216 is used. In an instance, the clustering ML model 216 is considered to be the DBSCAN model. As may be understood, the DBSCAN model is designed to discover the clusters along with the noise in spatial data.

In order to perform clustering of merchants, the data associated with the merchants, i.e., their corresponding set of key performance features have to be converted or reduced to a feature vector in a feature space. As may be understood, in machine learning and statistics, a “feature space” refers to the abstract mathematical space where data points are represented as feature vectors. Each feature vector corresponds to a data point and consists of numerical values, where each value represents a feature or attribute of the data point. In other words, each feature vector indicates a spatial representation of an individual merchant from the plurality of merchants 106 in the feature space. In various non-limiting examples, conventional techniques such as one-hot encoding, label encoding, count encoding, target encoding, and the like may be used for converting the set of key performance features corresponding to each merchant from the plurality of merchants 106 into a feature vector in the feature space. In the illustrated block diagram representation 400, any point in box 402 represents a feature vector corresponding to an individual merchant from the plurality of merchants 106.

In DBSCAN model, the term ‘core point’ refers to a point that has at least M points within distance N from itself, M and N being non-zero natural numbers, the term ‘border point’ refers to a point that has at least one core point at a distance N from itself, and the term ‘noise point’ refers to a point that neither is a core point nor a border point. In the illustrated representation 400, a box 404 contains depicts of the core point 406, the border point 408, and the noise point 410.

In a particular implementation, the Density-Based Spatial Clustering of Applications with Noise (DBSCAN) model, i.e., the clustering ML model 216 initiates the clustering process by arbitrarily selecting a point (i.e., a feature vector) from the input dataset (until all points have been visited). In this scenario, if there is at least a MinPts value or number of points within a radius of the epsilon value (i.e., E) to the selected point, then these points may be considered to belong to the same cluster. Further, the cluster is expanded by recursively repeating the neighborhood calculation for each neighboring point in the feature space. In the illustrated example, the MinPts value is set as 3.

More specifically, at first, the clustering ML model 216, initializes a first cluster, i.e., an empty cluster. Then, the clustering ML model 216 selects a merchant from the plurality of merchants 106 arbitrarily. Then, the clustering ML model 216 determines if the feature vector of the merchant is a core point based, at least in part, on the epsilon value and the MinPts value. Then, in response to determining that the feature vector of the merchant is the core point, the clustering ML model 216 adds the merchant to the first cluster. Otherwise, the clustering ML model 216 selects another point arbitrarily and repeats the same process till a core point is discovered. Upon determining the core point, the clustering ML model 216 determines a neighborhood for the merchant based, at least in part, on the epsilon value. It is noted that all the points present in the radius of the epsilon value from the selected point will be the neighbors of the selected point.

Then, the clustering ML model 216 performs a set of operations for each merchant in the neighborhood of the merchant. The set of operations includes adding the feature vector (i.e., a point) corresponding to each merchant in the neighborhood of the merchant to the first cluster. Then, the set of operations includes determining a secondary neighborhood for the feature vector corresponding to each merchant in the neighborhood of the merchant based, at least in part, on the epsilon value. Then, the set of operations includes adding each feature vector corresponding to each merchant in the secondary neighborhood to the first cluster. It is noted this set of operations is performed iteratively for all feature vectors corresponding to the plurality of merchants 106 till no additional merchant can be added to the first cluster.

Once, the generation of the first cluster is complete, the clustering ML model 216 is configured to initialize a second cluster, the second cluster being a noise cluster. Then, the clustering ML model 216 is configured to add the feature vectors corresponding to merchants outside the first cluster to the second cluster.

It is noted that during the operation of the clustering ML model 216 various steps may be performed to optimize the algorithm of the clustering ML model 216. To that end, for optimizing the clustering ML model 216, the ideal values of the epsilon and the MinPts have to be determined. As described earlier, MinPts values refer to the minimum number of points required to form a cluster, and the epsilon value refers to the radius of the cluster. The optimization process is shown by block 412.

To determine the MinPts value and the epsilon value, a KNN plot is generated based, at least in part, on the set of key performance features for each point (i.e., the feature vector corresponding to each merchant). A KNN plot is a visual representation of the relationships between different data points in a dataset based on their proximity to each other in a feature space. In other words, in the present context, the KNN plot generated using the feature vector corresponding to each merchant in the feature space represents the relationship between different merchants in the feature space. The process for generating a KNN plot includes computing for each feature vector corresponding to the plurality of merchants 106, K-nearest neighbors based, at least in part, on a distance (typically, Euclidean distance) between the various feature vectors in the feature space. Herein, K is a user-defined parameter that may be set by an administrator (not shown) of the server system 200. The K value defines how many nearest neighbors can be considered while generating the KNN plot. Further, the KNN graph or a plot is generated by the server system 200 such that each feature vector corresponding to the plurality of merchants 106 is represented as a node, and edges are drawn between the nodes that are among each other's K-nearest neighbors. For instance, if feature vector A corresponding to merchant A is among the K-nearest neighbors of feature vector B corresponding to merchant B, and vice versa, an edge is drawn between nodes A and B. Then, an estimated KNN plot is generated based, at least in part, on the KNN plot. Thereafter, the slope of the estimated KNN plot is determined. Further, the epsilon value and the MinPts value are determined based, at least in part, on the slope of the estimated KNN plot. In a particular implementation, the approximate epsilon value and approximate MinPts values from the estimated KNN plot by calculating the slope of the estimated KNN plot and determining the point where the slope of the KNN plot is close to 1.

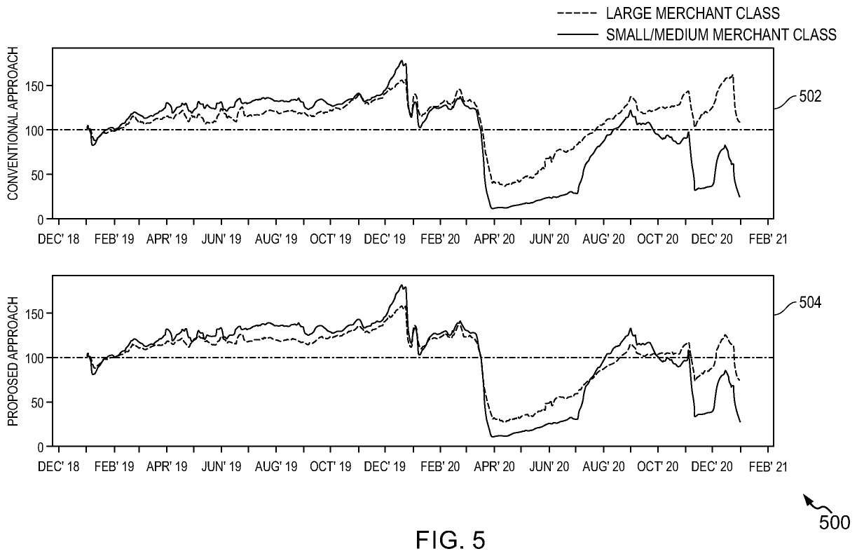

FIG. 5 illustrates experimental results 500 of an experiment performed in accordance with one or more embodiments of the present disclosure. It may be noted that to better understand the performance of the proposed approach, an experiment is conducted to analyze the performance of merchants during the COVID pandemic in the wake of the efforts by the United Kingdom (UK) government's policies that started a large-scale government subsidy aimed at encouraging people to eat out in restaurants in the wake of the first 2020 COVID-19 wave in the UK. According to reports, the scheme led to a significant increase in restaurant visits during August, which were greater than the visits during the corresponding period a year prior (i.e., August 2019). It was seen that the participation in recreational activities was also increased by 5-6% on the days that the scheme was active.

To determine the performance of merchants during this period, they had to be classified into small/medium class and large class. It is understood that the proposed merchant classification approach is able to classify more merchants as small or large while being more accurate than the conventional merchant classification approach. To that end, when trends or performance for small and large merchants are compared, the results produced by the proposed merchant classification approach are better. In the illustrated example, the graphs 502 and 504 illustrate the performance of the merchants in the UK during a predefined time period. It is noted that for generating the performance graph 502, the merchants were classified using the conventional merchant classification approach and for generating performance graph 504, the merchants were classified using the proposed merchant classification approach. As may be seen from the illustrated graphs 502 and 504, the graph 504 gives a more precise look into the performance of the small/medium merchants as their performance tracks in line with the performance recovery of the larger merchants while the graph 502 fails to track closely the performance of these merchants. In other words, the proposed approach is able to classify the merchants properly, thus leading to better performance figures.

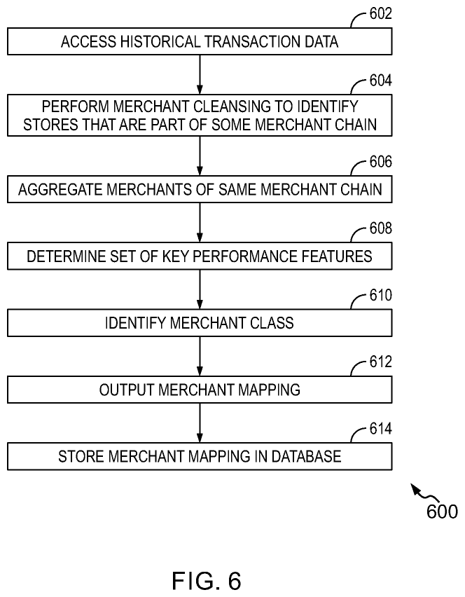

FIG. 6 illustrates a process flow diagram depicting a method 600 for identifying the merchant class of a merchant, in accordance with an embodiment of the present disclosure. The method 600 depicted in the flow diagram may be executed by, for example, the server system 200. The sequence of operations of the method 600 may not be necessarily executed in the same order as they are presented. Further, one or more operations may be grouped and performed in the form of a single step, or one operation may have several sub-steps that may be performed in parallel or in a sequential manner. Operations of the method 600, and combinations of operations in the method 600 may be implemented by, for example, hardware, firmware, a processor, circuitry, and/or a different device associated with the execution of software that includes one or more computer program instructions. The plurality of operations is depicted in the process flow of the method 600. The process flow starts at operation 602.

At 602, the method 600 includes accessing historical transaction data. In an instance, the historical transaction data may be accessed from the historical transaction dataset 220 from a database such as the database 204 associated with the server system 200. As described earlier, this historical transaction data may include transaction attributes related to a plurality of transactions performed between the plurality of cardholders 104 and the plurality of merchants 106.

At 604, the method 600 includes performing merchant cleansing to identify merchant stores or branches belonging to the same merchant chain or hierarchy. As described earlier, the data cleansing ML model 218 is used to perform the data cleaning by determining the root word for each merchant and then, determining the merchant hierarchy based on the determined root word.

At 606, the method 600 includes aggregating merchants of the same merchant chain to generate the merchant hierarchy.

At 608, the method 600 includes determining the set of key performance features for the merchant hierarchy. As may be understood, if 10 merchants are identified to be a part of the same merchant hierarchy then, the set of key performance features is computed cumulatively for these 10 merchants. In another example, if a single merchant is identified in a merchant hierarchy (i.e., if the merchant only has a single store), then the set of key performance features of that merchant is computed directly.

At 610, the method 600 includes identifying and labeling each merchant of the plurality of merchants 106 with the appropriate merchant class. In particular, at first, the clustering ML model 216 is used to form merchant clusters and then, the merchant clusters are labeled based on a classification threshold.

At 612, the method 600 includes outputting the merchant mappings to different classes. The merchant mapping indicates the merchant class of each merchant of the plurality of merchants 106.

At 614, the method 600 includes storing the merchant mapping in the database 204. In various non-limiting examples, the merchant mapping may further be used by the server system 200 to perform a variety of applications described earlier such as but not limited to determining the performance of each merchant class, computing Small Minus Big (SMB) performance index, determining industry level insights using data associated with the merchants from their corresponding merchant classes, determining geographical pain points for small, medium, or large merchant classes, tracking performance of merchants across industries, areas or regions, and the like.

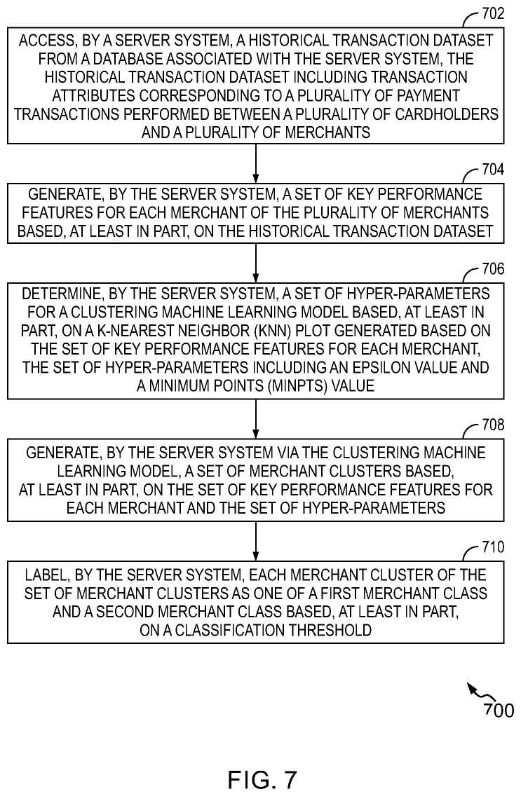

FIG. 7 illustrates a process flow diagram depicting a method 700 for performing merchant classification into different merchant classes, in accordance with an embodiment of the present disclosure. The method 700 depicted in the flow diagram may be executed by, for example, the server system 200. The sequence of operations of the method 700 may not be necessarily executed in the same order as they are presented. Further, one or more operations may be grouped and performed in the form of a single step, or one operation may have several sub-steps that may be performed in parallel or in a sequential manner. Operations of the method 700, and combinations of operations in the method 700 may be implemented by, for example, hardware, firmware, a processor, circuitry, and/or a different device associated with the execution of software that includes one or more computer program instructions. The plurality of operations is depicted in the process flow of the method 700. The process flow starts at operation 702.

At 702, the method 700 includes accessing, by a server system such as the server system 200, an historical transaction dataset such as the historical transaction dataset 220 from a database such as the database 204 associated with the server system 200, the historical transaction dataset 220 including transaction attributes corresponding to a plurality of payment transactions performed between the plurality of cardholders 104 and the plurality of merchants 106.

At 704, the method 700 includes generating, by the server system 200, a set of key performance features for each merchant of the plurality of merchants 106 based, at least in part, on the historical transaction dataset 220.

At 706, the method 700 includes determining, by the server system 200, a set of hyper-parameters for a clustering machine learning (ML) model such as the clustering ML model 216 based, at least in part, on a K-nearest neighbor (KNN) plot generated based on the set of key performance features for each merchant, the set of hyper-parameters including an epsilon value and a Minimum points (MinPts) value.

At 708, the method 700 includes generating, by the server system 200 via the clustering ML model 216, a set of merchant clusters based, at least in part, on the set of key performance features for each merchant and the set of hyper-parameters.

At 710, the method 700 includes labeling, by the server system 200, each merchant cluster of the set of merchant clusters as one of a first merchant class and a second merchant class based, at least in part, on a classification threshold.

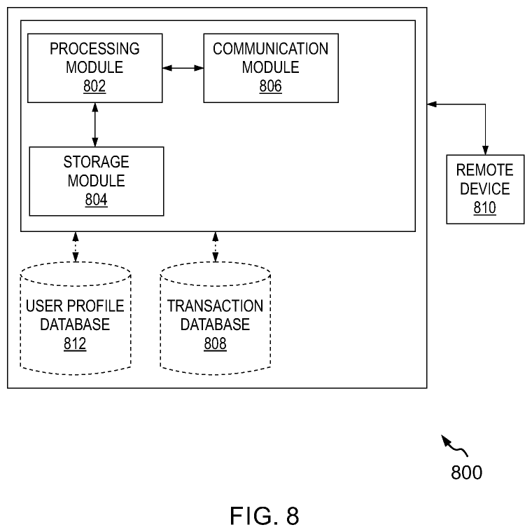

FIG. 8 illustrates a simplified block diagram of the acquirer server 800, in accordance with an embodiment of the present disclosure. The acquirer server 800 is an example of the acquirer server 108 of FIG. 1. The acquirer server 800 is associated with an acquirer bank/acquirer, in which a merchant may have an account. The acquirer server 800 includes a processing module 802 operatively coupled to a storage module 804 and a communication module 806. The components of the acquirer server 800 provided herein may not be exhaustive and the acquirer server 800 may include more or fewer components than those depicted in FIG. 8. Further, two or more components may be embodied in one single component, and/or one component may be configured using multiple sub-components to achieve the desired functionalities. Some components of the acquirer server 800 may be configured using hardware elements, software elements, firmware elements, and/or a combination thereof.

The storage module 804 is configured to store machine-executable instructions to be accessed by the processing module 802. Additionally, the storage module 804 stores information related to, the contact information of the merchant, bank account number, availability of funds in the account, payment card details, transaction details, and/or the like. Further, the storage module 804 is configured to store payment transactions.

In one embodiment, the acquirer server 800 is configured to store profile data (e.g., an account balance, a credit line, details of the merchant such as merchant 106(1), account identification information) in a transaction database 808. The details of the merchant 106(1) may include, but are not limited to, merchant name, age, gender, physical attributes, location, registered contact number, family information, alternate contact number, registered e-mail address, Merchant Category Code (MCC), merchant industry, merchant type, etc.

The processing module 802 is configured to communicate with one or more remote devices such as a remote device 810 using the communication module 806 over a network such as the network 116 of FIG. 1. The examples of the remote device 810 include the server system 102, the payment server 114, the issuer server 110, or other computing systems of the acquirer server 800, and the like. The communication module 806 is capable of facilitating such operative communication with the remote devices and cloud servers using Application Program Interface (API) calls. The communication module 806 is configured to receive a payment transaction request performed by the cardholder 104(1) of the plurality of cardholders 104 via the network 116. The processing module 802 receives payment card information, a payment transaction amount, and cardholder information from the remote device 810 (i.e., the payment server 114). The acquirer server 800 includes a user profile database 812 and the transaction database 808 for storing transaction data. The user profile database 812 may include information on the merchants. The transaction data may include, but is not limited to, transaction attributes, such as transaction amount, source of funds such as bank or credit cards, transaction channel used for loading funds such as POS terminal, transaction velocity features such as count and transaction amount sent in the past x days to a particular user, transaction location information, external data sources, and other internal data to evaluate each transaction.

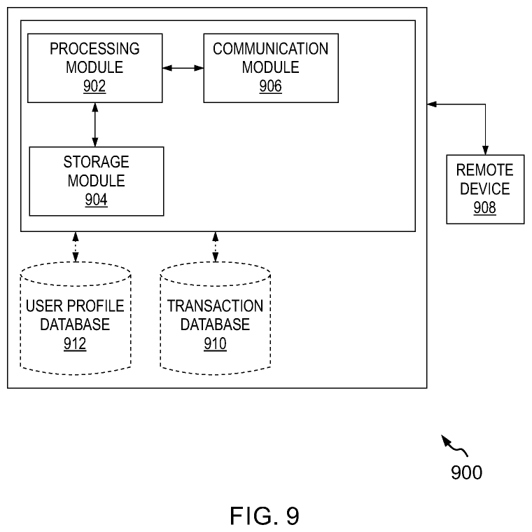

FIG. 9 illustrates a simplified block diagram of the issuer server 900, in accordance with an embodiment of the present disclosure. The issuer server 900 is an example of the issuer server 110 of FIG. 1. The issuer server 900 is associated with an issuer bank/issuer, in which an account holder (e.g., the plurality of cardholders 104(1)-104(N)) may have an account, which provides a payment card (e.g., the payment cards 118(1)-118(N)). The issuer server 900 includes a processing module 902 operatively coupled to a storage module 904 and a communication module 906. The components of the issuer server 900 provided herein may not be exhaustive and the issuer server 900 may include more or fewer components than those depicted in FIG. 9. Further, two or more components may be embodied in one single component, and/or one component may be configured using multiple sub-components to achieve the desired functionalities. Some components of the issuer server 900 may be configured using hardware elements, software elements, firmware elements, and/or a combination thereof.

The storage module 904 is configured to store machine-executable instructions to be accessed by the processing module 902. Additionally, the storage module 904 stores information related to, the contact information of the cardholders (e.g., the plurality of cardholders 104(1)-104(N)), a bank account number, availability of funds in the account, payment card details, transaction details, payment account details, and/or the like. Further, the storage module 904 is configured to store payment transactions.

In one embodiment, the issuer server 900 is configured to store profile data (e.g., an account balance, a credit line, details of the cardholders, account identification information, payment card number, etc.) in a database. The details of the cardholders may include, but are not limited to, name, age, gender, physical attributes, location, registered contact number, family information, alternate contact number, registered e-mail address, or the like of the cardholders, etc.

The processing module 902 is configured to communicate with one or more remote devices such as a remote device 908 using the communication module 906 over a network such as the network 116 of FIG. 1. Examples of the remote device 908 include the server system 200, the payment server 114, the acquirer server 108 or other computing systems of the issuer server 900. The communication module 906 is capable of facilitating such operative communication with the remote devices and cloud servers using API calls. The communication module 906 is configured to receive a payment transaction request performed by an account holder (e.g., the cardholder 104(1)) via the network 116. The processing module 902 receives payment card information, a payment transaction amount, customer information, and merchant information from the remote device 908 (e.g., the payment server 114). The issuer server 900 includes a transaction database 910 for storing transaction data. The transaction data may include, but is not limited to, transaction attributes, such as transaction amount, source of funds such as bank or credit cards, transaction channel used for loading funds such as POS terminal or ATM machine, transaction velocity features such as count and transaction amount sent in the past x days to a particular account holder, transaction location information, external data sources, and other internal data to evaluate each transaction. The issuer server 900 includes a user profile database 912 storing user profiles associated with the plurality of account holders.

The user profile data may include an account balance, a credit line, details of the account holders, account identification information, payment card number, or the like. The details of the account holders (e.g., the plurality of cardholders 104(1)-104(N)) may include, but are not limited to, name, age, gender, physical attributes, location, registered contact number, family information, alternate contact number, registered e-mail address, or the like of the cardholders 104.

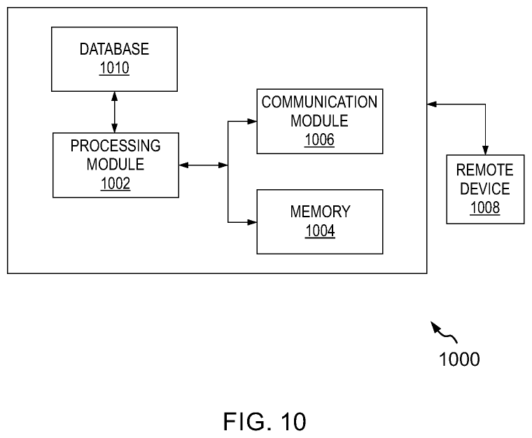

FIG. 10 illustrates a simplified block diagram of the payment server 1000, in accordance with an embodiment of the present disclosure. The payment server 1000 is an example of the payment server 114 of FIG. 1. The payment server 1000 and the server system 200 may use the payment network 112 as a payment interchange network. Examples of payment interchange networks include, but are not limited to, Mastercard® payment system interchange network.

The payment server 1000 includes a processing module 1002 configured to extract programming instructions from a memory 1004 to provide various features of the present disclosure. The components of the payment server 1000 provided herein may not be exhaustive and the payment server 1000 may include more or fewer components than that depicted in FIG. 10. Further, two or more components may be embodied in one single component, and/or one component may be configured using multiple sub-components to achieve the desired functionalities. Some components of the payment server 1000 may be configured using hardware elements, software elements, firmware elements, and/or a combination thereof.

Via a communication module 1006, the processing module 1002 receives a request from a remote device 1008, such as the issuer server 110, the acquirer server 108, or the server system 102. The request may be a request for conducting the payment transaction. The communication may be achieved through API calls, without loss of generality. The payment server 1000 includes a database 1010. The database 1010 also includes transaction processing data such as issuer ID, country code, acquirer ID, and Merchant Identifier (MID), among others.

When the payment server 1000 receives a payment transaction request from the acquirer server 108 or a payment terminal (e.g., IoT device), the payment server 1000 may route the payment transaction request to an issuer server (e.g., the issuer server 110). The database 1010 stores transaction identifiers for identifying transaction details such as transaction amount, IoT device details, acquirer account information, transaction records, merchant account information, and the like.

In one example embodiment, the acquirer server 108 is configured to send an authorization request message to the payment server 1000. The authorization request message includes, but is not limited to, the payment transaction request.

The processing module 1002 further sends the payment transaction request to the issuer server 110 for facilitating the payment transactions from the remote device 1008. The processing module 1002 is further configured to notify the remote device 1008 of the transaction status in the form of an authorization response message via the communication module 1006. The authorization response message includes, but is not limited to, a payment transaction response received from the issuer server 110. Alternatively, in one embodiment, the processing module 1002 is configured to send an authorization response message for declining the payment transaction request, via the communication module 1006, to the acquirer server 108. In one embodiment, the processing module 1002 executes similar operations performed by the server system 200, however, for the sake of brevity, these operations are not explained herein.

The disclosed method with reference to FIGS. 6-7, or one or more operations of the server system 200 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web (WWW), an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad scope of the invention. For example, the various operations, blocks, etc., described herein may be enabled and operated using hardware circuitry (for example, Complementary Metal Oxide Semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, Application Specific Integrated Circuit (ASIC) circuitry and/or Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause the processor or the computer to perform one or more operations. A computer-readable medium storing, embodying, or encoded with a computer program, or similar language, may be embodied as a tangible data storage device storing one or more software programs that are configured to cause the processor or computer to perform one or more operations. Such operations may be, for example, any of the steps or operations described herein. In some embodiments, the computer programs may be stored and provided to a computer using any type of non-transitory computer-readable media. Non-transitory computer-readable media includes any type of tangible storage media. Examples of non-transitory computer-readable media include magnetic storage media (such as floppy disks, magnetic tapes, hard disk drives, etc.), optical magnetic storage media (e.g. magneto-optical disks), Compact Disc Read-Only Memory (CD-ROM), Compact Disc Recordable (CD-R), compact disc rewritable (CD-R/W), Digital Versatile Disc (DVD), BLU-RAY® Disc (BD), and semiconductor memories (such as mask ROM, programmable ROM (PROM), (erasable PROM), flash memory, Random Access Memory (RAM), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based on these exemplary embodiments, it is noted that certain modifications, variations, and alternative constructions may be apparent and well within the scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
accessing, by a server system, a historical transaction dataset from a database associated with the server system, the historical transaction dataset comprising transaction attributes corresponding to a plurality of payment transactions performed between a plurality of cardholders and a plurality of merchants;
generating, by the server system, a set of key performance features for each merchant of the plurality of merchants based, at least in part, on the historical transaction dataset;
determining, by the server system, a set of hyper-parameters for a clustering machine learning model based, at least in part, on a K-nearest neighbor (KNN) plot generated based on the set of key performance features for each merchant, the set of hyper-parameters comprising an epsilon value and a Minimum points (MinPts) value;
generating, by the server system via the clustering machine learning model, a set of merchant clusters based, at least in part, on the set of key performance features for each merchant and the set of hyper-parameters; and
labeling, by the server system, each merchant cluster of the set of merchant clusters as one of a first merchant class and a second merchant class based, at least in part, on a classification threshold.

2. The computer-implemented method as claimed in claim 1, wherein generating the set of key performance features for each merchant, comprises:
determining, by the server system via a data cleansing machine learning model, a root word for each merchant of the plurality of merchants based, at least in part, on the historical transaction dataset;
determining, by the server system, a plurality of merchant hierarchies present in the plurality of merchants based, at least in part, on the root word determined for each merchant; and
generating, by the server system, the set of key performance features for each merchant hierarchy of the plurality of merchant hierarchies based, at least in part, on the historical transaction dataset.

3. The computer-implemented method as claimed in claim 2, wherein generating the set of key performance features for each merchant, further comprises:
normalizing, by the server system, each key performance feature of the set of key performance features based, at least in part, on a Minimum-Maximum (Min-Max) scaling process.

4. The computer-implemented method as claimed in claim 2, wherein the clustering machine learning model is a Density-Based Spatial Clustering of Applications with Noise (DBSCAN) based machine learning model and the data cleansing machine learning model is a Natural Language Processing (NLP)-based machine learning model.

5. The computer-implemented method as claimed in claim 1, further comprising:
generating, by the server system via the clustering machine learning model, a noise cluster based, at least in part, on the set of key performance features for each merchant and the set of hyper-parameters; and
determining, by the server system, the classification threshold based, at least in part, on a noise cluster.

6. The computer-implemented method as claimed in claim 1, wherein generating the set of merchant clusters via the clustering machine learning model, comprises:
generating, by the server system, a feature vector for each merchant of the plurality of merchants in a feature space based, at least in part, on the set of key performance features, wherein each feature vector indicates a spatial representation of an individual merchant from the plurality of merchants in the feature space;
initializing, by the server system, a first cluster, the first cluster being an empty cluster;
selecting, by the server system, a merchant from the plurality of merchants arbitrarily;
determining, by the server system, if the feature vector of the merchant is a core point based, at least in part, on the epsilon value and the MinPts value;
in response to determining that the feature vector of the merchant is the core point, adding, by the server system, the merchant to the first cluster;
determining, by the server system, a neighborhood for the merchant based, at least in part, on the epsilon value;
performing, by the server system, a set of operations for each merchant in the neighborhood of the merchant, the set of operations comprising:
adding the feature vector corresponding to each merchant in the neighborhood of the merchant to the first cluster;
determining a secondary neighborhood for the feature vector corresponding to each merchant in the neighborhood of the merchant based, at least in part, on the epsilon value; and
adding each feature vector corresponding to each merchant in the secondary neighborhood to the first cluster; and
performing, by the server system, the set of operations iteratively for feature vectors corresponding to the plurality of merchants till no additional merchant can be added to the first cluster.

7. The computer-implemented method as claimed in claim 6, further comprising:
initializing, by the server system, a second cluster, the second cluster being a noise cluster; and
adding, by the server system, the feature vectors corresponding to merchants outside the first cluster to the second cluster.

8. The computer-implemented method as claimed in claim 1, wherein the set of key performance features comprises revenue per cardholder, number of cardholders served, number of active merchant stores, number of postal presence, annual transaction value, annual transactions number, cross border transaction value, share of domestic to cross border transaction value, share of card present transactions, share of card-not-present transactions, share of credit to debit transaction value, average store footfall, transactions without card, value of credit transactions, value of sales per merchant store, and average ticket price.

9. The computer-implemented method as claimed in claim 1, wherein determining the set of hyper-parameters, comprises:
generating, by the server system, an estimated KNN plot based, at least in part, on the KNN plot;
determining, by the server system, a slope of the estimated KNN plot; and
determining, by the server system, the epsilon value and the MinPts value based, at least in part, on the slope of the estimated KNN plot.

10. The computer-implemented method as claimed in claim 1, wherein the server system is one of: a payment server associated with a payment network; and an acquirer server.

11. A server system, comprising:
a memory configured to store instructions;
a communication interface; and
a processor in communication with the memory and the communication interface, the processor configured to execute the instructions stored in the memory and thereby cause the server system to perform at least in part to:
access a historical transaction dataset from a database associated with the server system, the historical transaction dataset comprising transaction attributes corresponding to a plurality of payment transactions performed between a plurality of cardholders and a plurality of merchants;
generate a set of key performance features for each merchant of the plurality of merchants based, at least in part, on the historical transaction dataset;
determine a set of hyper-parameters for a clustering machine learning model based, at least in part, on a K-nearest neighbor (KNN) plot generated based on the set of key performance features for each merchant, the set of hyper-parameters comprising an epsilon value and a Minimum points (MinPts) value;
generate via the clustering machine learning model, a set of merchant clusters based, at least in part, on the set of key performance features for each merchant and the set of hyper-parameters; and
label each merchant cluster of the set of merchant clusters as one of a first merchant class and a second merchant class based, at least in part, on a classification threshold.

12. The server system as claimed in claim 11, wherein for generating the set of key performance features for each merchant, the server system is further caused, at least in part, to:
determine via a data cleansing machine learning model, a root word for each merchant of the plurality of merchants based, at least in part, on the historical transaction dataset;
determine a plurality of merchant hierarchies present in the plurality of merchants based, at least in part, on the root word determined for each merchant; and
generate the set of key performance features for each merchant hierarchy of the plurality of merchant hierarchies based, at least in part, on the historical transaction dataset.

13. The server system as claimed in claim 11, wherein for generating the set of key performance features for each merchant, the server system is further caused, at least in part, to:
normalize each key performance feature of the set of key performance features based, at least in part, on a Minimum-Maximum (Min-Max) scaling process.

14. The server system as claimed in claim 11, wherein for determining the set of hyper-parameters, the server system is further caused, at least in part, to:
generate an estimated KNN plot based, at least in part, on the KNN plot;
determine a slope of the estimated KNN plot; and
determine the epsilon value and the MinPts value based, at least in part, on the slope of the estimated KNN plot.

15. The server system as claimed in claim 11, wherein the server system is further caused, at least in part, to:
generate via the clustering machine learning model, a noise cluster based, at least in part, on the set of key performance features for each merchant and the set of hyper-parameters; and
determine the classification threshold based, at least in part, on a noise cluster.

16. The server system as claimed in claim 11, wherein for generating the set of merchant clusters via the clustering machine learning model, the server system is further caused, at least in part, to:
generate a feature vector for each merchant of the plurality of merchants in a feature space based, at least in part, on the set of key performance features, wherein each feature vector indicates a spatial representation of an individual merchant from the plurality of merchants in the feature space;
initialize a first cluster, the first cluster being an empty cluster;
select a merchant from the plurality of merchants arbitrarily;
determine if the feature vector of the merchant is a core point based, at least in part, on the epsilon value and the MinPts value;
in response to determining that the feature vector of the merchant is the core point, add the merchant to the first cluster;
determine a neighborhood for the merchant based, at least in part, on the epsilon value;
perform a set of operations for each merchant in the neighborhood of the merchant, the set of operations comprising:
adding the feature vector corresponding to each merchant in the neighborhood of the merchant to the first cluster;
determining a secondary neighborhood for the feature vector corresponding to each merchant in the neighborhood of the merchant based, at least in part, on the epsilon value; and
adding each feature vector corresponding to each merchant in the secondary neighborhood to the first cluster; and
perform the set of operations iteratively for feature vectors corresponding to the plurality of merchants till no additional merchant can be added to the first cluster.

17. The server system as claimed in claim 16, wherein the server system is further caused, at least in part, to:
initialize a second cluster, the second cluster being a noise cluster; and
add the feature vectors corresponding to merchants outside the first cluster to the second cluster.

18. The server system as claimed in claim 11, wherein the set of key performance features comprises revenue per cardholder, number of cardholders served, number of active merchant stores, number of postal presence, annual transaction value, annual transactions number, cross border transaction value, share of domestic to cross border transaction value, share of card present transactions, share of card-not-present transactions, share of credit to debit transaction value, average store footfall, transactions without card, value of credit transactions, value of sales per merchant store, and average ticket price.

19. A non-transitory computer-readable storage medium comprising computer-executable instructions that, when executed by at least a processor of a server system, cause the server system to perform a method comprising:
accessing a historical transaction dataset from a database associated with the server system, the historical transaction dataset comprising transaction attributes corresponding to a plurality of payment transactions performed between a plurality of cardholders and a plurality of merchants;
generating a set of key performance features for each merchant of the plurality of merchants based, at least in part, on the historical transaction dataset;
determining a set of hyper-parameters for a clustering machine learning model based, at least in part, on a K-nearest neighbor (KNN) plot generated based on the set of key performance features for each merchant, the set of hyper-parameters comprising an epsilon value and a Minimum points (MinPts) value;
generating via the clustering machine learning model, a set of merchant clusters based, at least in part, on the set of key performance features for each merchant and the set of hyper-parameters; and
labeling each merchant cluster of the set of merchant clusters as one of a first merchant class and a second merchant class based, at least in part, on a classification threshold.

20. The non-transitory computer-readable storage medium as claimed in claim 19, wherein generating the set of key performance features for each merchant comprises:
determining via a data cleansing machine learning model, a root word for each merchant of the plurality of merchants based, at least in part, on the historical transaction dataset;
determining a plurality of merchant hierarchies present in the plurality of merchants based, at least in part, on the root word determined for each merchant; and
generating the set of key performance features for each merchant hierarchy of the plurality of merchant hierarchies based, at least in part, on the historical transaction dataset.
